(19) United States
(12) Patent Application Publication
(10) Pub. No.: US 2002/0066493 A1
(43) Pub. Date: Jun. 6, 2002

(54) Process for refilling a container

(76) Inventors: Timothy Hewlitt, London (GB); Steven Kelsey, London (GB); William Maskell, London (GB); Jerard O'Brien, London (GB)

Correspondence Address: Yukiko Iwata, Shell Oil Company, Legal - Intellectual Property, P.O. Box 2463, Houston, TX, 77252-2463, US

(21) Appl. No.: 09/843,110

(22) Filed: Apr. 25, 2001

(30) Foreign Application Priority Data
Apr. 25, 2000 (EP) 00303471.7

(51) Int. Cl. B67C 3/00

(52) U.S. Cl. 141/10; 141/7; 141/59; 141/65; 141/313; 141/258; 141/285

(57) ABSTRACT

A process is provided for filling an at least partially collapsible container comprising one or more fill and/or dispense apertures. The collapsible container is evacuated prior to refilling the container.

This application claims priority to the foreign application filed on Apr. 25, 2000, in Europe and having a serial number of 00303471.7.

### FIELD OF THE INVENTION

The present invention relates to a process for refilling a container, particularly a sealed container, more particularly a collapsible container such as a sachet.

### BACKGROUND OF THE INVENTION

The filling of liquid products into containers can induce foaming, which has the effect of impeding the rate of fill and creating spillage of product. Foaming may even affect the constitution or structure of the liquid product itself.

A wide range of methods exists for controlling the foaming of products and these are used in a large number of situations.

Typically, these methods are used at the point of filling and are part of the filling machine.

There are examples in the art, wherein antifoaming methods are used within the design of a container or closure to improve the pouring and/or dispensing action of the container, for example, a beer closure for pouring beer into glasses prior to drinking.

There also exist methods for the filling of sachets that utilise filling through an open end while the sachet is part-manufactured. This is a preferred method as it allows product to be filled at speed and with little or no foaming action.

Alternative sachet filling techniques include filling through the dispense aperture whereby the filling method is to take a pre-manufactured sachet which is presented to the filling machine in a flat condition, that is to say there is substantially no chamber to fill into as the side walls of the sachet are in contact.

This method allows the sachet to be filled, whilst at the same time distending the pack structure and forming the fill chamber. This method reduces turbulence, which has the effect of controlling foaming.

In addition to production line filling machines, there also exist vending systems which are designed to fill containers at sites located in, for example, retail outlets, offices and other workplaces. Containers that are designed to work with these machines are typically filled through the dispense aperture or the open mouth of the container.

By “vending system” is meant a filling machine that dispenses product in response to one or more selections that are input into the machine by the user. Such a system may be operated by coin, token, card or other suitable means.

For both economic and environmental reasons, it is highly desirable to employ reusable containers, that is to say where the container is returned to the point of sale or dispense to be refilled once emptied of its contents. This process may be repeated many times, and the container may be refilled with contents different to those originally in the container.

Although methods exist for the filling of sachets while controlling the foaming action of the product, it is not typical for sachets to be refilled.

The refilling of reusable collapsible containers presents a number of problems if an antifoaming action is to be achieved. For example, the container needs to be collapsed, the container needs to be filled through the dispense aperture at high speed, thereby further increasing the potential for foaming, and the container to be refilled may be damaged and must be inspected for leaks before refilling.

By “collapsible” in the present invention, is meant any action that results in a reduction in size and volume of the container.

It is highly desirable to not only reduce the potential for foaming during refilling of a reusable container but to also inspect and assess if the condition of the reusable container is satisfactory for reuse. Of particular importance in filling machines, is the necessity to meet both of these criteria in a quick and efficient manner.

### SUMMARY OF THE INVENTION

According to the present invention there is provided a process for filling an at least partially collapsible container comprising one or more fill and/or dispense apertures, comprising the step of evacuating said container prior to refilling said container.

Evacuation of said container prevents a build up of air or gas pressure in the headspace of the container whilst it is being filled and eliminates the need for an exhaust arrangement.

By “headspace” is meant the space between the upper level (head) of the product stored in said container, and the limit of said cavity of said container.

Evacuation of the at least partially collapsible container prior to filling also prevents foaming, for example, of detergent products.

A further advantage of evacuation prior to filling is that such a process allows any leaks in said at least partially collapsible container to be detected. This is achieved by, for example, means which senses the pressure in the container during said evacuation.

In a preferred embodiment of the present invention, filling of the container is not commenced until a satisfactory reduced pressure has been applied to the container. Thus, any leaks present in the at least partially collapsible container will adversely affect the pressure of the system, thereby preventing filling, and causing the container to be subsequently rejected.

Hence, an evacuation process prior to filling not only reduces foaming, but it also provides an in-built system for the qualitative analysis of at least partially collapsible containers prior to refilling processes.

The process of the present invention, thereby maximises economic and environmental benefits by ensuring that said at least partially collapsible containers are used until the very end of their lifespan.

In a preferred embodiment of the present invention, the container is filled by a filling machine which is in the form of a vending system.

At least partially collapsible containers for the dispensing of products are well known in the art and are in widespread use. Such containers are available in a wide variety of shapes and forms. They may be assembled from a wide variety of components, and may be manufactured from a wide variety of materials.

In one embodiment of the present invention, said container may be manufactured from a plastics material. As such, said container may be manufactured by any conventional process for the forming of plastics materials. Suitable plastics materials include any appropriate to the requirements of the product including, by way of example, Polyethylene Terephthalate (PET), Polypropylene (PP), Polyethylene (PE), High Density Polyethylene (HDPE), Polyvinyl Chloride (PVC) and barrier laminates such as PET/NYLON/PET and PP/BAREX®/PP etc. (BAREX® is a trade mark of BP Amoco plc).

In a preferred embodiment of the present invention, said container is manufactured by an extrusion or injection blow-moulding process.

The at least partially collapsible container generally has a bottom wall, peripheral collapsible side walls, and an upper portion comprising one or more fill and/or dispense apertures. The terms “bottom”, “side” and “upper” are used to identify those positions of the container when it is in its normal orientation in use.

It will be appreciated by one skilled in the art, that for convenience, said bottom wall and/or upper portion may be also be of a collapsible nature.

The upper portion may be an integral part of the at least partially collapsible container, or it may be securely sealed to the peripheral collapsible side walls of the at least partially collapsible container by any technique commonly used in the art. Suitable techniques include heat sealing, ultrasonic sealing and the use of adhesives.

The at least partially collapsible container may be of any form commonly used in the art that allows a reduction in the size and volume of said container.

In a preferred embodiment of the present invention, the at least partially collapsible container may comprise a collapsible bag or sachet.

In a preferred embodiment of the present invention, the at least partially collapsible container may comprise one or more fill apertures and one or more dispense apertures, said fill apertures being remotely positioned on the container in relation to the dispense apertures.

By “remote” in the present invention, is meant at a location independent of the dispense aperture.

It will be appreciated that within the scope of the present invention, “remote” is also intended to encompass a situation wherein the fill aperture is located in the closure of the dispense aperture, i.e. whilst the fill aperture shares a common path to the interior of the container, the dispense aperture cannot be considered identical to that of the fill aperture.

The at least partially collapsible container may comprise any number, combination and orientation of fill and/or dispense apertures that meet the needs of the product, its intended use or its method of use.

The container may include any dispensing, dosing or application feature or device providing the means to dispense the product in a wide variety of ways.

The design of the container may include provision for manual or powered dispensing.

The container may include any device or mechanism for filling.

The nature of the dispense aperture closure is not limited and may be of any kind commonly used in the art.

In a preferred embodiment of the present invention, the fill aperture may be located in the closure of the dispense aperture. As such, the container design may be simplified, in that the container requires only a single aperture.

The nature of the fill aperture closure is not limited in the present invention, and may be of any kind commonly used in the art, provided that said fill aperture closure can open and re-close by some function of the filling process, by the action of the filling machine, or a mechanism thereof, or by the inherent nature of the fill aperture.

In a preferred embodiment of the present invention, the fill aperture closure may comprise a reed valve. Reed valves are known in the art and are typically employed in footballs, wherein the football is filled with air via such a needle valve.

The location of the or each fill aperture is not limited in the present invention, however in a preferred embodiment of the present invention, the one or more fill apertures will be centrally located on the container.

By “centrally located” in the present specification is meant, that the location of the fill aperture or apertures provides a symmetry thereby allowing the container to be filled independent of the orientation of the container around a vertical axis when placed in the filling machine.

In a preferred embodiment of the present invention, the collapsible container is evacuated through one or more fill apertures, preferably one or more remote fill apertures.

The preferred central location of said one or more fill apertures, further serves to ensure a uniform collapse of the collapsible container upon evacuation.

By “evacuation” in the present invention is meant a pressure preferably below 16.9 kPa (5 in Hg), more preferably below 10.2 kPa (3 in Hg) and most preferably below 3.4 kPa (1 in Hg).

It will be appreciated that evacuation may be applied through one or more filling heads of a filling machine, or through an additional piece or pieces of apparatus located in the filling point of said filling machine.

By “filling head” in the present invention, is meant the nozzle of the filling machine which dispenses the product. It will be appreciated that the filling machine may comprise multiple filling heads.

By “filling point” in the present invention, is meant the region of the filling machine in which a container is placed for filling to occur.

In a preferred embodiment of the present invention, the filling head acts both as the means for evacuation and as the means for dispensing product.

The degree to which the filling head may be inserted into the collapsible container is not limited in the present invention. In a preferred embodiment, however, the filling head will be extended into said container such that it allows bottom filling.

By “bottom filling” in the present invention, is meant that the tip of the filling head contacts, or is very closely adjacent to, the bottom of the collapsible container, that is to say incoming product is not discharged into the headspace but into the body of product already present inside said container.

In a further embodiment of the present invention, one or more tubes may extend, as one or more components of the collapsible container, from one or more fill aperture closures to the base of said collapsible container, thereby acting as guides allowing easy insertion of the filling heads down to the base of said collapsible container.

Said tubes may be arranged in any fashion across the width of the container.

In a preferred embodiment of the present invention, said tubes comprise a plurality of vent points along their lengths, thereby allowing a distributed filling of the collapsible container. This has the advantage of eliminating the need for the filling heads to be extended to the base of said collapsible container.

In the case of a collapsible bag or sachet, the integral fill tubes may be formed from the fabric of said bag or sachet. Said tubes may be formed by sealing channels with interrupted seals into the walls of said bag or sachet. Said integral fill tubes may be arranged in a variety of configurations and with a variety of apertures to allow filling of materials with varying viscosities and other characteristics such as particulates.

It is preferred that said fill tubes are circumferential fill tubes with apertures facing into the body of the bag or sachet.

In a preferred embodiment, said fill tubes are half the height of the collapsible container, with a single bottom aperture, thereby allowing filling from the centre of the bag or sachet.

In a further preferred embodiment, said fill tubes are positioned to the side of the collapsible container with the aperture at the base, to allow corner filling of the collapsible container.

Containers according to the present invention may be conveniently used to store and transport a wide variety of materials such as foodstuffs, beverages, household products such as detergents, and automotive products such as lubricants.

### BRIEF DESCRIPTION OF THE DRAWINGS

The present invention will be described by way of example, with reference to the accompanying drawings. It is to be noted, however, that the accompanying drawings illustrate only some embodiments of the invention and are therefore not to be considered limiting of its scope, because the invention may admit to other equally effective embodiments.

FIG. 1 is a cutaway perspective view of a container comprising remote fill and dispense apertures, with a filling head inserted into said remote fill aperture, prior to a filling process being commenced,

FIG. 2 is a cutaway perspective view similar to FIG. 1 but during a filling process,

FIG. 3 is a cutaway perspective view similar to FIG. 1 but once the filling process is complete, and said machine filling head has been removed from said remote fill aperture; and

FIG. 4 is a schematic cross-section of one embodiment of the container.

### DETAILED DESCRIPTION OF THE INVENTION

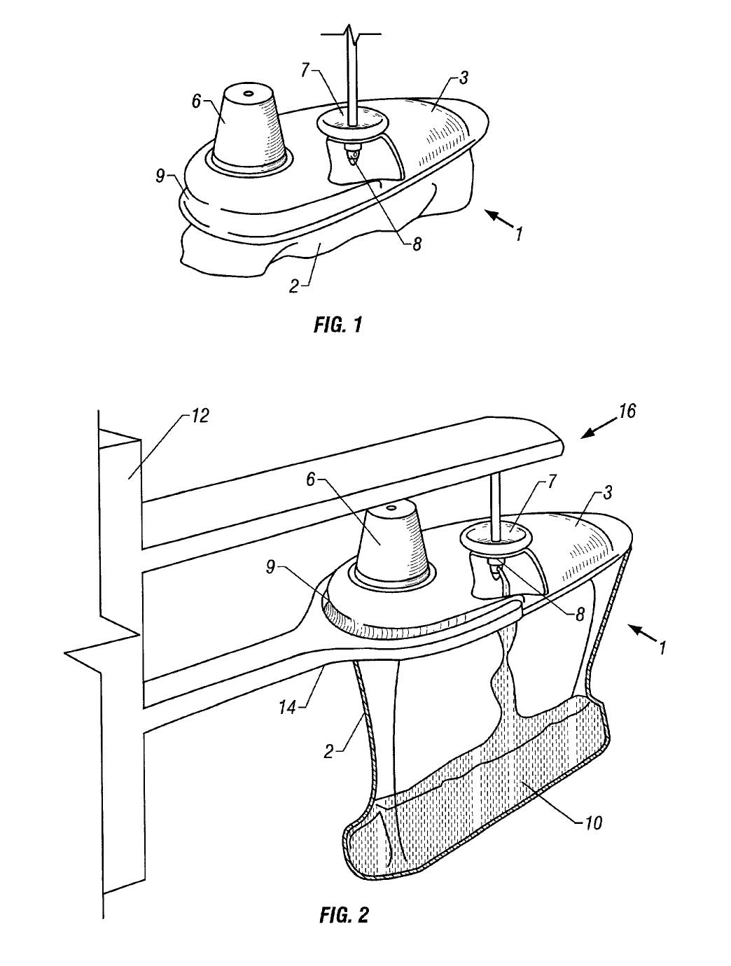

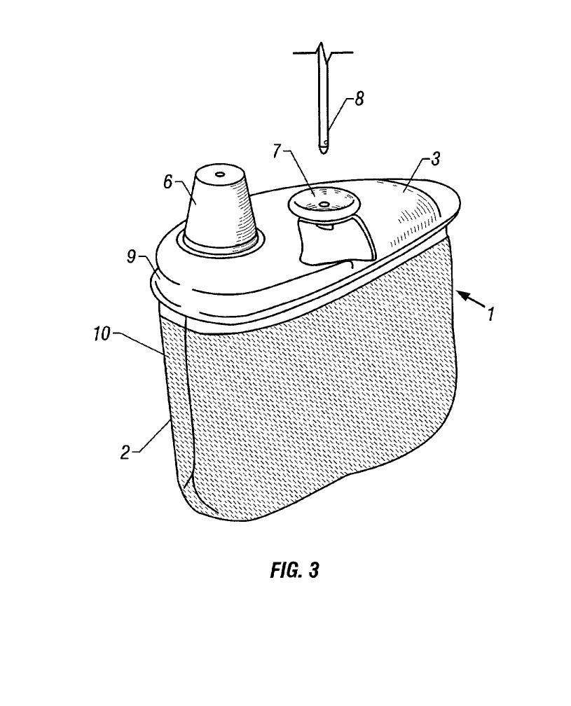

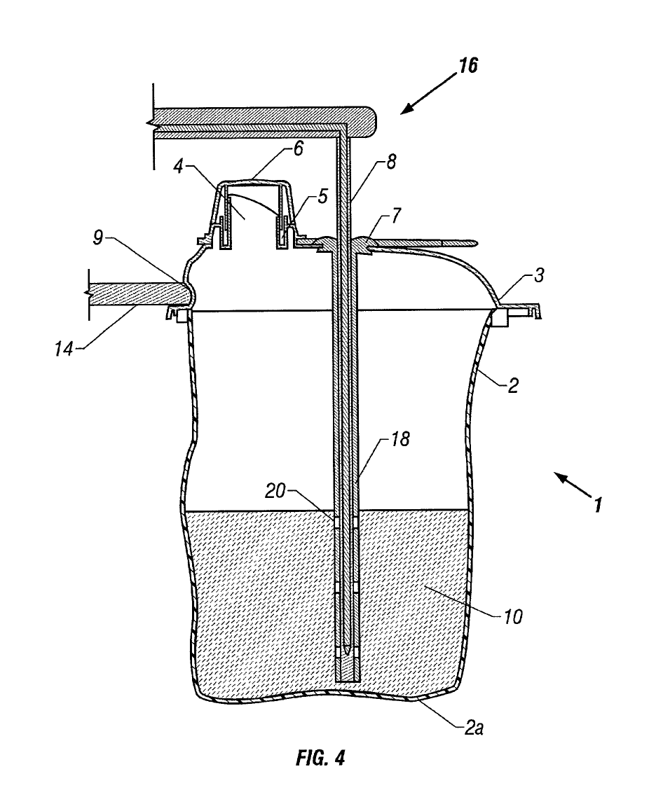

FIGS. 1-4 have similar elements that are similarly numbered and will be described in conjunction with each other.

A container 1 comprises a collapsible bag 2 which is attached to a rigid or semi-rigid upper portion 3. Said upper portion 3 comprises a dispense aperture 4. The dispense aperture 4 is provided with a drip trap 5 and a removable cap 6. Said upper portion 3 further comprises a remote fill aperture 7, in the form of a reed valve. Said remote fill aperture 7 is centrally-located within said upper portion 3, such that the collapsible bag 2 undergoes uniform collapse upon evacuation through a needle valve 8, or any other suitable means, in a filling head of a filling machine 12.

As shown in FIG. 1, evacuation of the collapsible bag 2 results in its substantial contraction in volume.

Furthermore, said upper portion 3 is provided with a positioning groove 9 which, upon insertion of said container 1 into a filling machine 12 engages with corresponding protrusions 14 in said filling machine to ensure correct positioning of said container 1 in said filling machine. Such engagement of said positioning groove 9 and corresponding protrusions may also serve to retain said container 1 in said filling machine during a filling operation.

Said collapsible container may be filled with liquid product 10, during the filling process through the needle valve 8 of the filling machine 12.

The filling machine 12 generally uses a filling head 16. In some embodiments, the filling head 16 can be extended into the collapsible bag 2 to allow bottom filling. In such cases, the collapsible bag 2 may include one or more tubes 18 coupled to the bag 2 that extend near the base 2a of the collapsible bag 2. The tubes can also include one or more vent points 20 along their length.

While the foregoing is directed to various embodiments of the present invention, other and further embodiments may be devised without departing from the basic scope thereof. For example, the various methods and embodiments of the invention can be included in combination with each other to produce variations of the disclosed methods and embodiments. Also, the directions such as “top,” “bottom,” “left,” “right,” “upper,” “lower,” and other directions and orientations are described herein for clarity in reference to the figures and are not to be limiting of the actual device or system or use of the device or system. The device or system may be used in a number of directions and orientations. Further, the order of steps can occur in a variety of sequences unless otherwise specifically limited. The various steps described herein can be combined with other steps, interlineated with the stated steps, and/or split into multiple steps.

1. A process for filling an at least partially collapsible container comprising one or more fill and/or dispense apertures comprising at least partially evacuating said container prior to refilling said container.

2. The process according to claim 1, wherein evacuating comprises applying a vacuum through one or more filling heads of a filling machine.

3. The process according to claim 1, wherein the evacuating said collapsible container comprises evacuating through one or more fill apertures.

4. The process according to claim 2, wherein the evacuating said collapsible container comprises evacuating through one or more fill apertures.

5. The process according to claim 1, wherein evacuating said container comprises evacuating through one or more remote fill apertures.

6. The process according to claim 3, wherein said one or more fill apertures are centrally located.

7. The process according to claim 2, further comprising extending said filling head into said collapsible container to allow bottom filling.

8. The process according to claim 7, wherein one or more tubes extend as one or more components of the collapsible container from one or more fill aperture closures toward a base of said container.

9. The process according to claim 8, wherein said tubes comprise a plurality of vent points along their length.

10. The process according to claim 2, further comprising using a vending system to fill the container.

11. The process according to claim 7, further comprising using a vending system to fill the container.

12. The process according to claim 1, wherein the collapsible container comprises a bag or sachet.

13. The process according to claim 2, wherein the collapsible container comprises a bag or sachet.

14. The process according to claim 7, wherein the collapsible container comprises a bag or sachet.

15. The process according to claim 8, wherein the collapsible container comprises a bag or sachet.

16. The process according to claim 9, wherein the collapsible container comprises a bag or sachet.
